(19) United States
(12) Patent Application Publication
(10) Pub. No.: US 2005/0071175 A1
(43) Pub. Date: Mar. 31, 2005

(54) Device for temporarily overcoming the loss of a satellite navigation signal, for satellite navigation-based dual toll systems

(76) Inventors: Janos Gila, Modling (AT); Wolfgang Konrad, Molding (AT)

Correspondence Address: HARNESS, DICKEY & PIERCE, P.L.C., P.O.BOX 8910, RESTON, VA, 20195, US

(21) Appl. No.: 10/493,539

(22) PCT Filed: Oct. 16, 2002
(86) PCT No.: PCT/DE02/03921

(30) Foreign Application Priority Data
Oct. 22, 2001 (AT) 16802001

(51) Int. Cl. G06F 17/60

(52) U.S. Cl. 705/1; 705/13

(57) ABSTRACT

The invention relates to a method for electronically charging tolls, whereby actual position coordinates (OKO) of a vehicle are determined by means of at least one position fixing system, in order to determine if a toll road segment has been taken. Said position coordinates (OKO) are determined at least temporarily by means of a satellite-aided position fixing system (SGS). At least one signature (SIG), which is characteristic of the road segment taken by said vehicle, is calculated by means of said position coordinates of the vehicle (FA1, FA2). Said signature (SIG) permits the determination of whether the road segment taken is a toll road segment or not. At least in case of partial failure of said satellite-aided position fixing system (SGS), the position coordinates are determined by means of an inertial navigation system (TNS).

This application is the national phase under 35 U.S.C. § 371 of PCT International Application No. PCT/DE02/03921 which has an International filing date of Oct. 16, 2002, which designated the United States of America and which claims priority on Austrian Patent Application number AT 1680/2001. filed Oct. 22, 2001, the entire contents of which is hereby incorporated herein by reference.

### FIELD OF THE INVENTION

The invention generally relates to a method for electronic toll payment, Preferably, it relates to one in which, in order to determine whether the road which is being driven on is subject to toll, current position coordinates of a vehicle are determined. This is preferably done by using at least one position determination system, with the position coordinates being determined at least at times by way of a satellite-based position determination system.

The invention also generally relates to a toll system for electronic toll payment. Preferably, it relates to one which has at least one satellite-based position determination system for determination of the current position coordinates of a vehicle.

### BACKGROUND OF THE INVENTION

A toll system and a method has been disclosed in DE 43 44 433 A1. In the known method, current position coordinates are recorded by a GPS receiver and are compared with the entry/exit coordinates, which are stored internally in an electronic label, for a turnpike section. If the coordinates match, these are transmitted via a digital mobile network to a payment center, which is external to the vehicle, with the distance traveled on the turnpike. The turnpike charges associated with this distance are then calculated from the transmitted data in the payment center.

WO 95/20801 discloses a method and an apparatus for determination of usage charges for roadways and/or traffic areas. Here, the position data of the vehicle is recorded via a satellite-based position determination system. It is then compared with the positions of virtual toll points.

The position data can be transmitted to a control center which is external to the vehicle in order to calculate the toll charges, in which case the charges can also be calculated in a toll-payment apparatus in the vehicle. The charges determined can then be transmitted to the control center, where they can then be debited from an account. This method has the particular disadvantage that the position of the vehicle must be recorded all the time, and there is no capability for anonymous debiting.

WO 99/33027 describes a method for payment of toll charges, in which the current position of the vehicle is determined via a satellite-based position determination system, and is compared with the position of a virtual toll point in order to calculate the toll charges. A communication link is set up between the vehicle and a central toll control point when a vehicle drives through a physical toll station, in order to pay the toll charges incurred. Once the payment transaction has been carried out, a communication link via which verification of correct payment of the toll charge is transmitted is set up between the toll station and the vehicle.

One disadvantage of the known method is that no toll charges can be calculated if the communication link between the vehicle and the payment center or between the vehicle and the position determination system fails. A further disadvantage of the known toll systems is that position determination is no longer possible in the event of a failure of the satellite-based position determination system. In this case, correct toll payment can no longer be guaranteed with the known toll systems.

### SUMMARY OF THE INVENTION

One object of an embodiment of the invention is to overcome at least one of the disadvantages mentioned above.

An object may be achieved, according to an embodiment of the invention, by a method. Here, at least one signature, which is characteristic of the road on which the vehicle is being driven, is calculated on the basis of the position coordinates of the vehicle. The signature is then used to determine whether the road being driven on is subject to a toll. The position coordinates are determined using an inertial navigation system at least in the event of a partial failure of the satellite-based position determination system.

One advantageous feature of an embodiment of the invention is that the use of a road which is subject to a toll can be verified even when no permanent communication is possible between a position determination system and the vehicle, since the signature of the road being driven on allows association with roads that are subject to tolls. The capability to determine the position coordinates by way of the inertial navigation system allows correct toll payment to be guaranteed even in the event of failure of the satellite-based position determination system.

One advantageous variant of an embodiment of the invention provides for the position coordinates to be determined in a reception area of the satellite-based position determination system via the satellite-based position determination system and the inertial navigation system.

Further advantages can be achieved in that data from the inertial navigation system is used rather than a number of position determination data items, which can be predetermined, from the satellite-based position determination system. This can be done as a function of the quality of the position determination data from the satellite-based position determination system, in order to calculate the position coordinates.

Furthermore, the signature can be calculated from a number, which can be predetermined, of position coordinates which are determined via the satellite-based position determination system, and from a number, which can be predetermined, of position coordinates which are determined via the inertial navigation system.

A toll system is particularly suitable for carrying out the method according to an embodiment of the invention. Such a system may be designed to calculate at least one signature, which is characteristic of the road being driven on by the vehicle, on the basis of position coordinates of the vehicle. It can further use the signature to determine whether the road being driven on is subject to a toll. An inertial navigation system can be provided on board the vehicle. The system may further be designed to determine the position coordinates, at least in the event of a partial failure of the satellite-based position determination system.

In one preferred variant of an embodiment of the invention, a toll-payment apparatus may be provided on board the vehicle and may be designed to determine the position coordinates in a reception area of the satellite-based position determination system via the satellite-based position determination system and the inertial navigation system.

Furthermore, the toll-payment apparatus can be designed to use position determination data originating from the inertial navigation system rather than a number, which can be predetermined, of position determination data items from the satellite-based position determination system, as a function of the quality of the position determination data from the satellite-based position determination system, in order to calculate the position data.

Furthermore, the toll-payment apparatus can be designed to calculate the signature from a number, which can be predetermined, of position coordinates, which are determined by way of the satellite-based position determination system, and from a number, which can be predetermined, of position coordinates determined by means of the inertial navigation system.

### BRIEF DESCRIPTION OF THE DRAWINGS

The invention will be explained in more detail together with further advantages in the following text and with reference to a number of non-restrictive exemplary embodiments which are illustrated in the drawings, in which:

FIG. 1 shows a toll system according to an embodiment of the invention, and

FIG. 2 shows a schematic procedure for the method according to an embodiment of the invention.

### DETAILED DESCRIPTION OF THE PREFERRED EMBODIMENTS

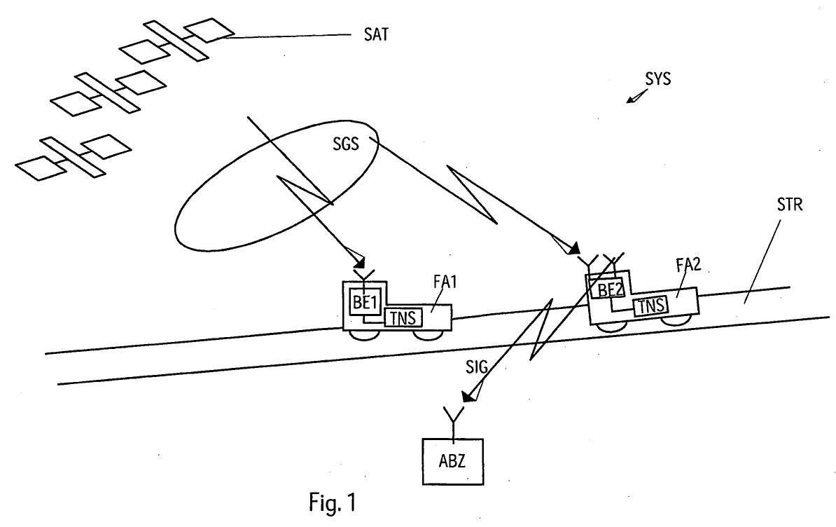

As is shown in FIG. 1, a toll system SYS according to an embodiment of the invention for location of a vehicle FA1, FA2 has a satellite-based position finding system SGS, for example the known “Global Positioning System” or GPS system, for short, as well as an inertial navigation system TNS which is arranged on board the vehicle FA1, FA2. As will be explained in more detail in the following text, the toll system SYS according to an embodiment of the invention allows a dual toll system to be produced in a simple manner.

For the purposes of this document, a dual toll system is a toll system which allows not only payment of the toll charges directly to a toll-payment apparatus, which is designed specifically for this purpose, in the vehicle without any communication with a payment center external to the vehicle, but also allows payment of toll charges via a payment center ABZ, with the vehicle in the second case having to have a toll-payment apparatus which is designed for communication with the payment center ABZ.

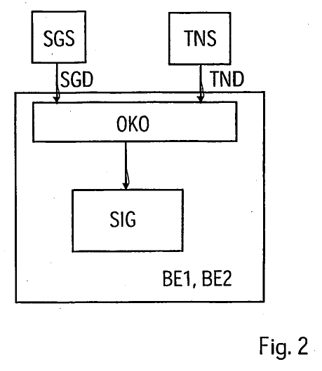

In order to determine the current position coordinates OKO, the vehicles FA1, FA2 have a respective toll-payment apparatus BE1, BE2, which is designed to interchange data with the satellite navigation system SGS and the inertial navigation system TNS (FIG. 2), and in which case the toll-payment apparatuses BE1, BE2 may, for example, be in the form of smart cards.

If the satellite navigation system SGS is the GPS system, then the toll-payment apparatus BE1, BE2 may have a GPS module or may be connected to such a module. In order to improve the accuracy, position correction data may be determined using the dGPS method and may be transmitted via a radio network, for example the GSM network, etc, to the GPS module. A method such as this for transmission of correction data has been disclosed, for example, in WO 94/12892.

For road or position determination via GPS and dGPS, reference should be made, for example, to “Umgebungserfassung auf Basis lernender digitaler Karten zur vorausschauenden Konditionierung von Fahrerassistenzsystemen” [Environmental recording on the basis of learnt digital maps for predictive conditioning of driver assistance systems]; Michael Schraut; Dissertation to the Faculty of Electrical Engineering and Information at the Technology at the Technical University of Munich.

Large numbers of inertial navigation systems TNS are also known. For example, EP 1 096 230 describes an inertial navigation system for vehicles, which can be used together with a GPS system or in conjunction with some other navigation system to determine the position of a vehicle.

The central problem with inertial navigation is, as is known, the autonomous determination of the trajectory, for example, traveled by a vehicle, of the orientation and of the navigation parameters (velocities, accelerations) from the data supplied from an inertial navigation measurement unit. A reference system must be defined for determination of these parameters. The three primary inertial navigation systems are three-dimensionally stabilized inertial platforms, strap-down systems and geographically oriented inertial systems [“Simulation des Verhaltens einer low-cost Strapdown IMU unter Laborbedingungen” [Simulation of the response of a low-cost strap-down IMU in laboratory conditions]; Raul Dorobantu; Technical University of Munich, Institute for Astronomical and Physical Geodesy].

The combination of a satellite-based position determination system SGS with an inertial navigation system TNS provides the capability for continuous position calculation. This is true since position reports are provided even when there is no satellite reception (GPS reception). Furthermore, the accuracy of the determined position can be considerably improved by continuous comparison of fluctuating GPS data with the inertial navigation system TNS.

The reception of GPS signals in large cities is subject to many difficulties since GPS systems may be blocked and reflected by tall buildings. These reflections normally cause position-finding problems, so that the position coordinates OKO of the vehicle FA1, FA2 cannot be unambiguously determined. These position-finding errors can be avoided by way of the inertial navigation system TNS.

A person skilled the art may make use of known commercially available GPS receivers or modules as well as inertial navigation systems TNS to implement the method according to an embodiment of the invention.

In principle, the current position coordinates OKO of the vehicle FAR can be determined according to an embodiment of the invention in three different ways:
1. Determination of the position coordinates OKO by use of the inertial navigation system-TNS
2. Determination of the position coordinates OKO by use of the satellite navigation system SGS
3. Determination of the position coordinates OKO by use of the satellite navigation system SGS and the inertial navigation system TNS.

In the first and second cases, the respective other position determination system which is currently not in use may be used to determine the current position coordinates OKO if the other system fails.

In the third variant, the data SGD, TND from the two position determination systems can be compared with one another (permanently or at time intervals which can be predetermined). Alternatively, depending on the quality of the data SGD from the satellite navigation system SGS, this data SGD may be replaced by data TND from the inertial navigation system TNS in order to improve the accuracy in the determination of the position coordinates OKO.

All three variants have the common feature that they ensure continuous recording of the position of the vehicle—in this context see also: “Zur Erweiterung einer im Telematikbereich eingesetzten Navigationseinheit um einen Rotationssensor” [On the addition of a rotation sensor to a navigation system that is used in the field of telematics]; Rita Tschammer Osten; Diploma thesis at the Technical University of Munich, Institute for Astronomic and Physical Geodesy”. The position data SGD, TND originating from the two different systems can be supplied to the toll-payment apparatus BE1, BE2 for further processing.

It is, of course, also possible for some of the position coordinates OKO which are used for further calculation to be determined exclusively by use of the inertial navigation system TNS, and for some others to be determined exclusively by use of the satellite-based position determination system SGS.

It is then possible to use the position coordinates OKO determined by the toll-payment apparatus BE1, BE2 to decide, in the manner described in the following text, whether the road STR being driven on is subject to a toll.

As is shown in FIG. 2, a characteristic signature SIG, for example in the form of trains of polygons on which determined position coordinates OKO are located, can be calculated from the position coordinates OKO obtained in the vehicle-mounted toll-payment apparatuses BE1, BE2 at intervals, which can be predetermined, for the respective road STR being driven on. To decide whether this is a road that is subject to a toll, a comparison with roads on a reference map or reference signatures can be done which, for example, are likewise in the form of polygon trains. This can be done, for example, by way of methods that are known from the field of pattern recognition, to identify similarity or a match.

The road which is being driven on may be characterized as being subject to a toll if there is a good match between the signature SIG and the reference signature. Payment may then take place in accordance with payment model which can be predetermined. The reference map and reference signatures may in this case be stored either in the toll-payment apparatus BE1 or in the payment center ABZ that is external to the vehicle.

In the first case, the toll-charge may be debited, for example, from a credit that is stored in the toll-payment apparatus BE1 in the vehicle FA1 and which can be charged by way of a toll prepayment card. The credit may be transferred from the prepayment card to the toll-payment apparatus in a manner as known, for example, from the field of mobile radio telephony. A time card or a rotation credit may also be stored in this toll-payment apparatus BE1, depending on the desired payment model.

Another possible way to pay toll charges is for the toll-payment apparatus BE2 to have a communication unit, for example a GSM module, via which the signature SIG or toll charges are transmitted together with an identifier for the toll-payment apparatus BE2 to a payment center ABZ which is external to the vehicle, where payment is made.

One advantage of an embodiment of the invention is that the inertial navigation system TNS which is used need not be of the same quality as that which is normally demanded of inertial navigation systems TNS that are used for navigation purposes. This is true since only short-term accuracy is necessary—for example for the time period in which the satellite-based position determination system SGS has failed—so that the production costs can be reduced considerably.

1. A method for an electronic toll, wherein position coordinates of a vehicle normally determinable via a satellite-based position determination system, comprising:
calculating at least one signature, characteristic of a road on which a vehicle is traveling upon, based upon the position coordinates of the vehicle; and
using the calculated at least one signature to determine whether the road being traveled upon is subject to a toll, wherein the position coordinates are determinable using an inertial navigation system, at least in an event of a partial failure of the satellite-based position determination system.

2. The method as claimed in claim 1, wherein, in a reception area of the satellite-based position determination system, the position coordinates are determined via the satellite-based position determination system and the inertial navigation system.

3. The method as claimed in claim 2, wherein position determination data from the inertial navigation system is used rather than a number of position determination data items, which are predeterminable from the satellite-based position determination system as a function of the quality of the position determination data from the satellite-based position determination system, in order to calculate the position coordinates.

4. The method as claimed in claim 2, wherein the at least one signature is calculated from a predeterminable number of position coordinates, determinable via the satellite-based position determination system, and from a predeterminable number of position coordinates, determinable via the inertial navigation system.

5. A toll system, comprising:
at least one satellite-based position determination system for determination of position coordinates of a vehicle; and
means for calculating at least one signature, characteristic of a road being traveled upon by the vehicle, based upon position coordinates of the vehicle, and for using the signature to determine whether the road being traveled upon is subject to a toll, wherein an inertial navigation system, provided on board the vehicle, is designed to determine the position coordinates at least in the event of a partial failure of the satellite-based position determination system.

6. The toll system as claimed in claim 5, wherein a toll-payment apparatus, provided on board the vehicle, is designed to determine the position coordinates in a reception area of the satellite-based position determination system using the satellite-based position determination system and the inertial navigation system.

7. The toll system as claimed in claim 6, wherein the toll-payment apparatus is designed to use portion determination data originating from the inertial navigation system rather than a predeterminable number of position determination data items from the satellite-based position determination system, as a function of the quality of the position determination data from the satellite-based position determination system, in order to calculate the position data.

8. The toll system as claimed in claim 6, wherein the toll-payment apparatus is designed to calculate the signature from a predeterminable number of position coordinates, determinable via the satellite-based position determination system, and from a predeterminable number of position coordinates determinable via the inertial navigation system.

9. The method as claimed in claim 3, wherein the at least one signature is calculated from a predeterminable number of position coordinates, determinable via the satellite-based position determination system, and from a predeterminable number of position coordinates, determinable via the inertial navigation system.

10. The toll system as claimed in claim 7, wherein the toll-payment apparatus is designed to calculate the signature from a predeterminable number of position coordinates, determinable via the satellite-based position determination system, and from a predeterminable number of position coordinates determinable via the inertial navigation system.

11. A toll system, wherein at least one satellite-based position determination system is normally used for determination of position coordinates of a vehicle, the toll system comprising:
means for calculating at least one signature, characteristic of a road being traveled upon by the vehicle, based upon position coordinates of the vehicle; and
means for determining whether the road being traveled upon is subject to a toll using the calculated at least one signature, wherein an inertial navigation system, provided on board the vehicle, is designed to determine the position coordinates at least in the event of a partial failure of the satellite-based position determination system.

12. The toll system as claimed in claim 11, wherein a toll-payment apparatus, provided on board the vehicle, is designed to determine the position coordinates in a reception area of the satellite-based position determination system using the satellite-based position determination system and the inertial navigation system.

13. The toll system as claimed in claim 12, wherein the toll-payment apparatus is designed to use position determination data originating from the inertial navigation system rather than a predeterminable number of position determination data items from the satellite-based position determination system, as a function of the quality of the position determination data from the satellite-based position determination system, in order to calculate the position data.

14. The toll system as claimed in claim 12, wherein the toll-payment apparatus is designed to calculate the signature from a predeterminable number of position coordinates, determinable via the satellite-based position determination system, and from a predeterminable number of position coordinates determinable via the inertial navigation system.

15. The toll system as claimed in claim 13, wherein the toll-payment apparatus is designed to calculate the signature from a predeterminable number of position coordinates, determinable via the satellite-based position determination system, and from a predeterminable number of position coordinates determinable via the inertial navigation system.

16. A method, wherein position of a vehicle is normally determinable via a satellite-based position determination system, comprising:
calculating at least one signature, characteristic of a road on which a vehicle is traveling upon, based upon position of the vehicle; and
determining, using the calculated at least one signature, whether the road being traveled upon is subject to a toll, wherein the position is determinable using an inertial navigation system, at least in an event of the satellite-based position determination system failing to determine position.

17. The method as claimed in claim 16, wherein, in a reception area of the satellite-based position determination system, the position is determined via the satellite-based position determination system and the inertial navigation system.

18. The method as claimed in claim 17, wherein position determination data from the inertial navigation system is used rather than a number of position determination data items, which are predeterminable from the satellite-based position determination system as a function of the quality of the position determination data from the satellite-based position determination system, in order to calculate the position coordinates.

19. The method as claimed in claim 17, wherein the at least one signature is calculated from a predeterminable number of position coordinates, determinable via the satellite-based position determination system, and from a predeterminable number of position coordinates, determinable via the inertial navigation system.
